(19) United States
(12) Patent Application Publication
(10) Pub. No.: US 2011/0161310 A1
(43) Pub. Date: Jun. 30, 2011

(54) DATABASE QUERY PLAN ANALYSIS AND DIFFERENCE PROCESSING

(76) Inventors: Wei Tang, Torrance, CA (US); Dehui Zhang, Beijing (CN)

(21) Appl. No.: 12/649,608

(22) Filed: Dec. 30, 2009

(51) Int. Cl. G06F 17/30

(52) U.S. Cl. 707/714; 707/718; 707/E17.017

(57) ABSTRACT

Apparatus, systems, and methods may operate to retrieve at least a portion of a first database query plan comprising a first tree and at least a portion of a second database query plan comprising a second tree. Further activities may include comparing relations and operations in the first tree and the second tree to identify differences. The differences may be found in the join order of the relations, and/or deleted, inserted, updated, or swapped ones of the operations based on operation signatures. Potential regression in query plan performance based on the differences may be indicated using a visual and/or audible alarm, and the differences may be published. Additional apparatus, systems, and methods are disclosed.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example screen shots, images, and source code described below and in any drawings included herewith: Copyright© 2009, Teradata, Inc. of Miamisburg, Ohio—All Rights Reserved.

### BACKGROUND

Businesses increasingly operate to capture, store, and mine a plethora of information related to communications with their customers and other events. Often this information is stored and indexed within databases. Once the information is indexed, queries can be developed on an as-needed basis to mine the information in the database to suit a variety of organizational goals.

A query execution plan (also known as a “query plan” hereinafter) is a sequence of activities indicating how information is to be accessed within a database management system in response to a query. A graphical representation of the query plan often makes it easier for users to quickly grasp information about the operations included in the plan, which can be useful for debugging and performance tuning. These graphical representations are sometimes available in the form of trees that include node link diagrams and enclosure representations (“execution plan trees”). However, when two similar plans are presented in this format to a user, especially when there are many branches in each tree, it can be relatively difficult to determine differences between the plans.

### BRIEF DESCRIPTION OF THE DRAWINGS

FIG. 1 is a block diagram of a database query plan comprising an execution plan tree, according to various embodiments of the invention.

FIG. 2 illustrates the structure of union, intersect, and minus operations, according to various embodiments of the invention.

FIG. 3 illustrates the structure of retrieve, join, aggregate, and sort operations, according to various embodiments of the invention.

FIG. 4 includes block diagrams of simplified execution plan trees, and execution plan trees illustrating the same operation join order and different operation join orders, according to various embodiments of the invention.

FIG. 5 includes block diagrams of execution plan trees illustrating deleted operations and inserted operations, according to various embodiments of the invention.

FIG. 6 includes block diagrams of execution plan trees illustrating updated operations and swapped operations, according to various embodiments of the invention.

FIG. 7 illustrates a graphical user interface that highlights the differences between execution plan trees, according to various embodiments of the invention.

FIG. 8 is a flow diagram illustrating methods to identify and process differences between execution plan trees, according to various embodiments of the invention.

FIG. 9 is a block diagram of apparatus and systems according to various embodiments of the invention.

FIG. 10 is a block diagram of an article of manufacture, including a specific machine, according to various embodiments of the invention.

### DETAILED DESCRIPTION

A database query execution plan usually comprises a set of actions, and their sequential or parallel relationships, that a database engine can use to access or modify information. A change in query performance (e.g., elapsed time, CPU and I/O cost) is usually observed after a change is made to the query plan, given a system configuration that otherwise remains the same. Therefore, when a regression in query performance is observed, it can be useful to locate query plan changes so that potential problems may be identified in the new plan. Unfortunately, this can be difficult to accomplish.

For example, the plans may exist in free-text form that is difficult to parse and compare. In addition, query plans often do not have a proper logical level abstraction (e.g., to indicate join orders). The result is an abundance of false alarms and distractions due to verbose descriptions within the plan.

To address some of these challenges, a signature-based method may be used to compare database query execution plans. Thus, for any two plans that correspond to a given query, the mechanisms described herein can be used to develop signatures for each of two query plans, and then to make a comparison between the signatures. The results of the comparison can then be used to help answer the following questions:
Are the two plans identical to each other?
Do the two plans have the same join order?
Are there operations existing in one plan but not in the other?
Do operations that exist in both plans have the same characteristics?
Are operations in one plan being swapped in the other plan?

For the purposes of this document, the following definitions will be observed.

A “relation” refers to a set of tuples that have the same attributes. Thus, a relation may comprise a base table, a materialized view, or a temporary result of an operation called a “spool”, among others.

A “spool” may in some cases comprise the physical representation of a relation on disk. The attributes of a spool include, but are not limited to: spool identification (id), spool size, row count (e.g., rows in a database), geography, confidence, cache flag, and spool schema. Some of these attributes may exist as estimates or actual numbers, depending on whether the plan takes the form of a compile-time plan or a run-time plan, respectively. Spools may or may not be included in a diagram representing a given query plan, due to their temporary existence.

“Operations” take a set of relations and operate on the set to yield a relation as a result. Operations may comprise one of several basic types: union, intersect, minus, retrieve, join, aggregate and sort. Each type of operation has its own properties. This set of operations somewhat resembles the operators used in relational algebra, but are used here in a more general way. For example, select and project operators are collapsed into a retrieve operation in the following examples. New N-ary operations can be constructed by connecting existing operations and relations.

Every operation takes one or more relations or other operations as its operands and has a signature by which it is uniquely identified in an execution plan. For example, a join operation is described by its left relation, its right relation, and its join condition; and a retrieve operation is described by its base relation and its residual condition. A set operation such as intersect or minus is described by its left relation and its right relation.

An “execution plan”, such as a database query execution plan, comprises a tree of relations and operations. “Leaf nodes” in a tree comprise base tables and/or materialized views, while “intermediate nodes” in the tree comprises operations, such as retrieve, join, etc.

A “table” within the data store may include a schema that defines the relationship between one or more elements in the data store. For example, the relationship between data store element “household” to element “individual” and to element “account” may be expressed as (household->individual->account). The schema defines the fields or elements of the data store. Schema relationships may be hierarchical or many-to-many.

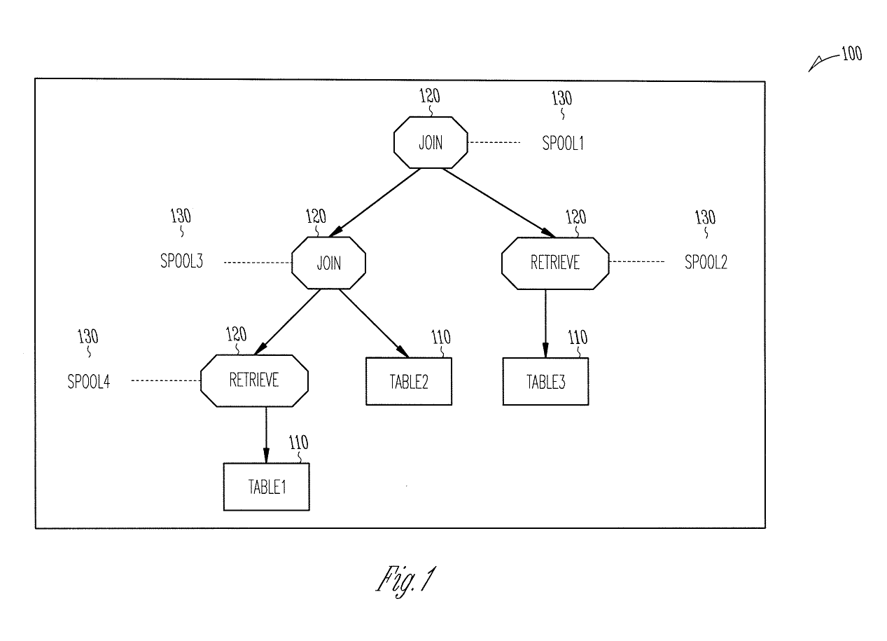

FIG. 1 is a block diagram of a database query plan comprising an execution plan tree 100, according to various embodiments of the invention. Thus, it can be seen that an execution plan may comprise a tree 100 of relations 110 and operations 120. Spools 130 are also shown.

Available commercial database software often gives the user the capability to export the execution plan corresponding to a query. Given two execution plans in tree format, as shown in FIG. 1, many embodiments operate to recursively locate all of the matched signatures within the two plans. The remaining, unmatched elements comprise the differences between the two plans. An algorithm is described below that can be used to find differences in: join order, deleted operations, inserted operations, updated operations, and swapped operations.

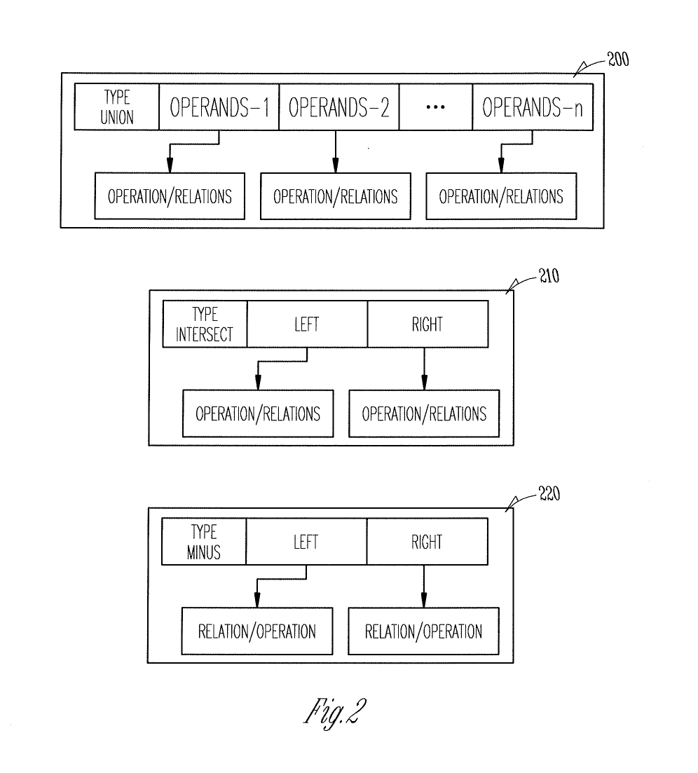

FIG. 2 illustrates the structure of union operations 200, intersect operations 210, and minus operations 220, according to various embodiments of the invention. The properties of a union operation 200 include having operands that comprise an unordered set of at least two relations and/or operations. The union operation acts to unite all of the specified relations and operations into a single set.

The properties of an intersect operation 210 include having operands that comprise an unordered set of only two relations or operations as operands. The intersect operation acts to supply a single set of relations and operations that result from retaining the intersection of the specified left operations and relations with the specified right operations and relations.

The properties of a minus operation include having operands that comprise an ordered set of only two relations or operations as operands. The minus operation acts to supply a single set of relations and operations that remain after removing the intersection of the specified left operations and relations with the specified right operations and relations.

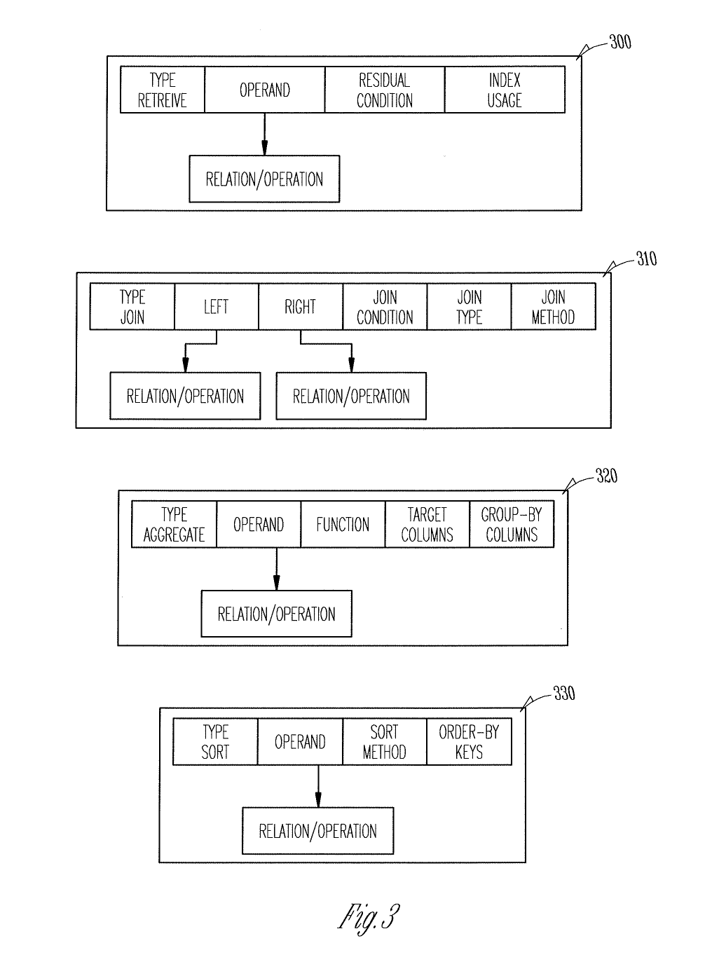

FIG. 3 illustrates the structure of retrieve operations 300, join operations 310, aggregate operations 320, and sort operations 330, according to various embodiments of the invention. The properties of a retrieve operation 300 include having operands that comprise a set of one relation or operation. Residual condition properties can be used for filtering the relations and operations that are retrieved, such as filtering rows. Index usage properties can be used to specify which indexes are to be accessed as a part of the retrieve operation, such as a primary index, a secondary index (can be used to get data from a relation, perhaps with residual conditions to filter rows), or a hash index, among others. The retrieve operation thus acts to retrieve the specified operand or relation, according to the conditions specified properties.

The properties of a join operation 310 include having left, right, full, or inner join types. Additional properties of join operations 310 include having operands that comprise an ordered set of two relations or operations if the joint type is left or right, and an unordered set of two relations or operations if the join type if full or inner. A join operation 310 may also be characterized by properties that include join conditions, and the join method: hash, merge, nested loop, etc. The join operation thus acts to combine the specified operations and relations according to the conditions by the properties.

The properties of an aggregate operation 320 include having operands that comprise a set of one relation or operation. An aggregate operation 320 may be characterized by properties that include function (sum, count, max, min or average), target columns (i.e., the column(s) on which the function operates), and the group-by columns (column(s) by which the tuples are grouped). The aggregate operation thus acts to apply the specified function to the tuples in the specified relation or operation.

The properties of a sort operation 330 include having operands that comprise a set of one relation or operation. Sort operations can also be characterized by properties that include order-by keys (column(s) by which tuples are sorted), and the sort method, which is the algorithm used to sort the tuples. The sort operation thus acts to order tuples in a relation or operation according to the sort method.

The “signature” of an operation is a minimal subset of its properties that collectively can be used to distinguish one operation from another. A property in this subset is called a “key property.” A property not in this subset is called a “descriptive property.”

All properties of union, intersect, minus, or aggregate operations are key properties. A retrieve operation's key properties are its type, operand, and residual condition. A join operation's key properties are its type, operands, join type, and join condition. A sort operation's key properties are its type, operand and its order-by keys.

For operations other than join operations, two operations have the same signature if and only if all of their key properties are equal. Two join operations have the same signatures if and only if:
for a left or right join, the two join operations have an equivalent ordered operand set, join condition, and join type; and
for an inner or full join, the two join operations must have an equivalent unordered operand set, join condition, and join type.

To determine when two operations have the same signature, their operation types and key properties within the operation types are compared. In other words, the types of the operations are matched first, and then the key properties for each operation type are matched as well.

Comparing sets of operands within operations takes into account the number of operands, and whether the operands are ordered, or not. Thus, when a set of one element is to be compared between operations, the comparison involves comparing one element in the first set with the other element in the second set.

A comparison of an ordered set of two elements is decomposed into a comparison in which the first element of the first set is compared to the first element of the second set, and the second element of the first set is compared to the second element of the second set. Only when such element comparisons (including order) result in a match can the ordered set be considered equivalent.

As a matter of contrast, a comparison of an unordered set of two elements is decomposed into two comparisons in which the first element of the first set is compared to the first element of the second set, and the second element of the first set is compared to the second element of the second set, or the first element of the first set is compared to the second element of the second set, and the second element of the first set is compared to the first element of the second set. In this case, if either one of the two comparisons results in a match, then the two unordered sets are considered equivalent.

In many embodiments, query plan trees are compared based on signatures of operations in order to find differences. The pseudo-code listing of actions that can be used for signature comparison of operations within two trees is listed below, in Table I:

TABLE I
/* Algorithm sigMatch recursively takes two nodes to the roots of two
query plan trees and returns a “true” flag value (indicates a match)
when the two trees' signatures match; otherwise “false” is returned. */
boolean sigMatch (TreeNode NodeA, TreeNode NodeB)
{

/* baseTable nodes are terminal/leaf nodes. This is the terminating

condition for the recursion */

if ((NodeA.Type==NodeB.Type==′baseTable′) and

(NodeA.ID=NodeB.ID))

return true;

/* Trees do not match if the corresponding nodes have different

fanout degrees or the node types are different */

if ((NodeA.Degree<>NodeB.Degree) or

(NodeA.Type<>NodeB.Type))

{

NodeA.Match=NULL;
NodeB.Match=NULL;
return false;

}
flag=false;
/* signature matching according to operation types */
switch(NodeA.Type)
{
case ′union′:
case ′intersect′:

if (sigMatch(NodeA.left, NodeB.left) and (NodeA.right,

NodeB.right)) or

(sigMatch(NodeA.left, NodeB.right) and (NodeA.right,

NodeB.left))

flag=true;

break;

case ′minus′:

if (sigMatch(NodeA.left, NodeB.left) and (NodeA.right,

NodeB.right))

flag=true;

break;

case ′retrieve′:

if (NodeA.cond<>NodeB.cond)

break;

if (sigMatch(NodeA.opd, NodeB.opd)

flag=true;

break;

case ′join′:

if (NodeA.cond<>NodeB.cond)

break;
if (NodeA.JType<>NodeB. JType)
break;

if (NodeA.JType==”Left” ∥ NodeA.JType==”Right”)
{

if (sigMatch(NodeA.left, NodeB.left) and (NodeA.right,

NodeB.right))

{

flag=true;
break;

}

}
else
{

if (sigMatch(NodeA.left, NodeB.left) and (NodeA.right,

NodeB.right)) or

(sigMatch(NodeA.left, NodeB.right) and (NodeA.right,

NodeB.left))

{

flag=true;
break;

}

}

case ′sort′:

if (NodeA.Okey<>NodeB.Okey)

break;

if (sigMatch(NodeA.opd, NodeB.opd)

flag=true;

break;

case ′aggregate′:

if (NodeA.Okey<>NodeB.Okey) or

```
  (NodeA.Glist<>NodeB.GList) or
  (NodeA.AFun<>NodeB.AFun)
break;
```

if (sigMatch(NodeA.opd, NodeB.opd)

flag=true;

break;

}
/* The two plan trees match */
if (flag)
{

NodeA.Match=&NodeB;
NodeB.Match=&NodeA;

}
return flag;

}

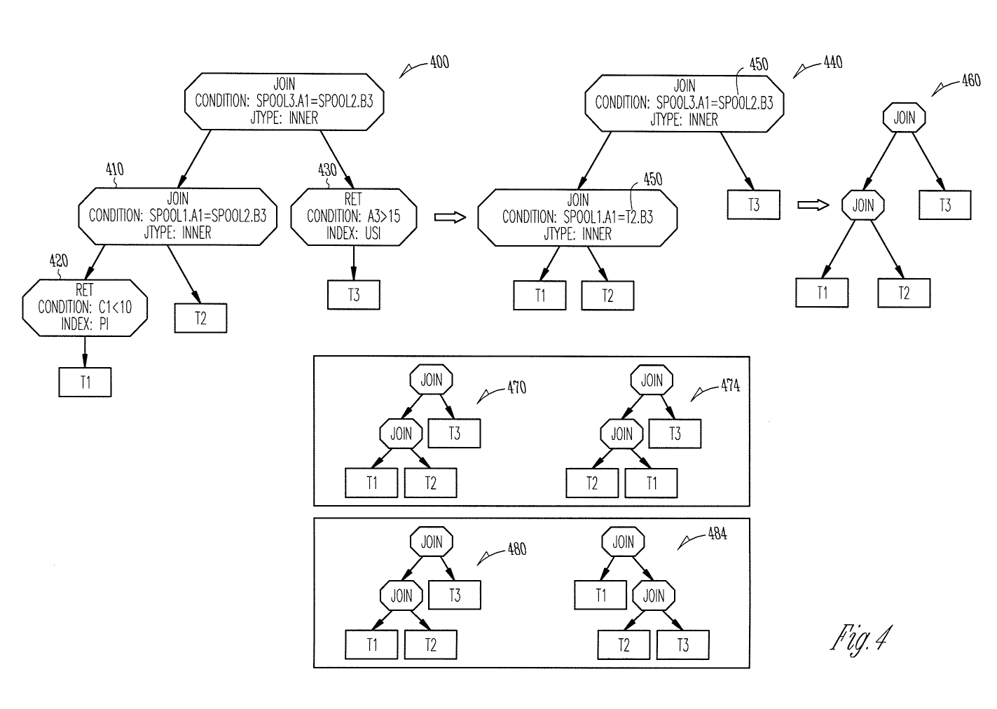

When comparing operations, there are four types of comparison results that accrue:
differences in join order,
deleted operations (existing in the first plan but not in the second plan),
inserted operations (existing in the second plan but not in the first plan),
updated operations (existing in both plans but with different descriptive properties), and
swapped operations (existing in both plans, with the same parent, but in different child order). FIGS. 4-6 describe each of these in more detail.

FIG. 4 includes block diagrams of simplified execution plan trees, and execution plan trees illustrating the same operation join order and different operation join orders, according to various embodiments of the invention. To find differences in join order, an execution plan tree 400 can be simplified by removing operations having a degree of one (i.e., unary operations) and linking the child of the operation to its parent. For example, a join operation 410 having a retrieve operation 420 on the first base table T1 as the first operand, and a second base table T2 as the second operand, is essentially a join operation on the first base table and the second base table. The simplified tree 440 can be further simplified by keeping operation type and operands, and removing all other properties 450 of the specified operations because they are irrelevant to join order. The end result is that a transformed tree 460 represents a clean join order of the original execution plan without unnecessary details.

In terms of join operation order, it can be noted that in a first scenario 470, the result of joining a first base table T1 to a second base table T2, which is then joined with a third base table T3 would be, in terms of join order, equivalent to a second scenario 474 in which the result of joining the second base table T2 to the first base table T1 is then joined with the third base table T3.

As a matter of contrast, it can be seen that in a third scenario 480, the result of joining a first base table T1 to a second base table T2, which is then joined with a third base table T3 would not be, in terms of join order, equivalent to a fourth scenario 484 in which the first base table T1 is joined to the result of joining the second base table T2 to the third base table T3.

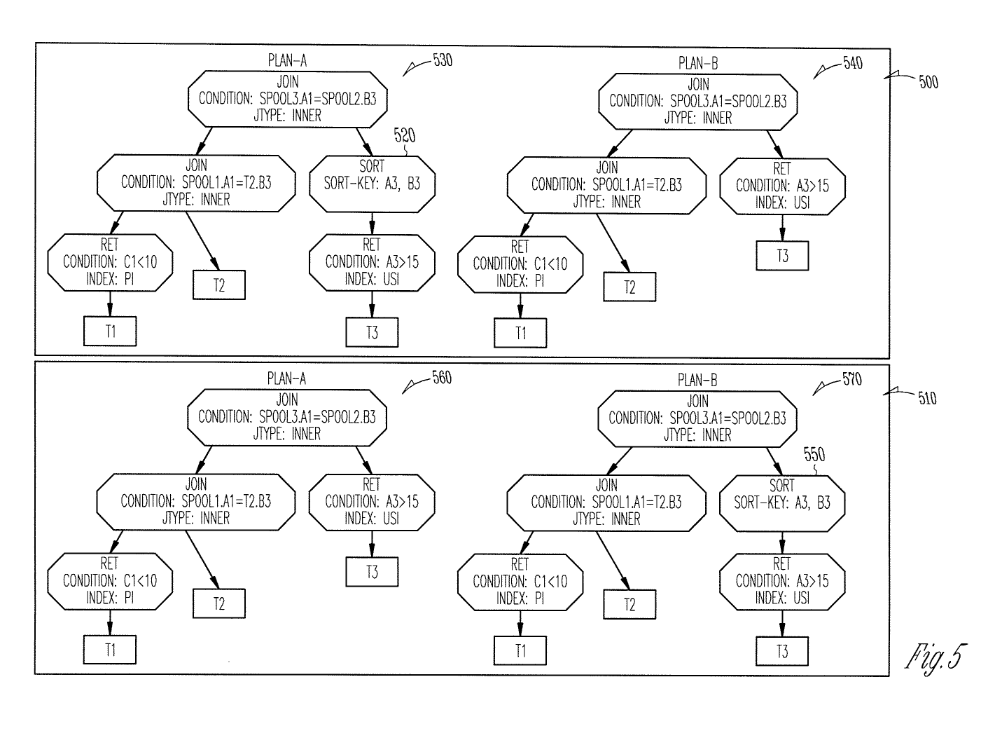

FIG. 5 includes block diagrams 500, 510 of execution plan trees illustrating deleted operations 520 and inserted operations 550, according to various embodiments of the invention. To find deleted operations 520, operation signatures in both plans 530, 540 are compared to see if an operation exists in the first plan 530 but not in the second plan 540. For example, it can be seen that there is a sort operation in the first plan 530, but not in the second plan 540. Thus, the sort operation is a deleted operation 520.

To find inserted operations 550, operation signatures in both plans 560, 570 are compared to see if an operation exists in the second plan 570 but not in the first plan 560. For example, it can be seen that there is a sort operation in the second plan 570, but not in the first plan 560. Thus, the sort operation in this case is an inserted operation 550.

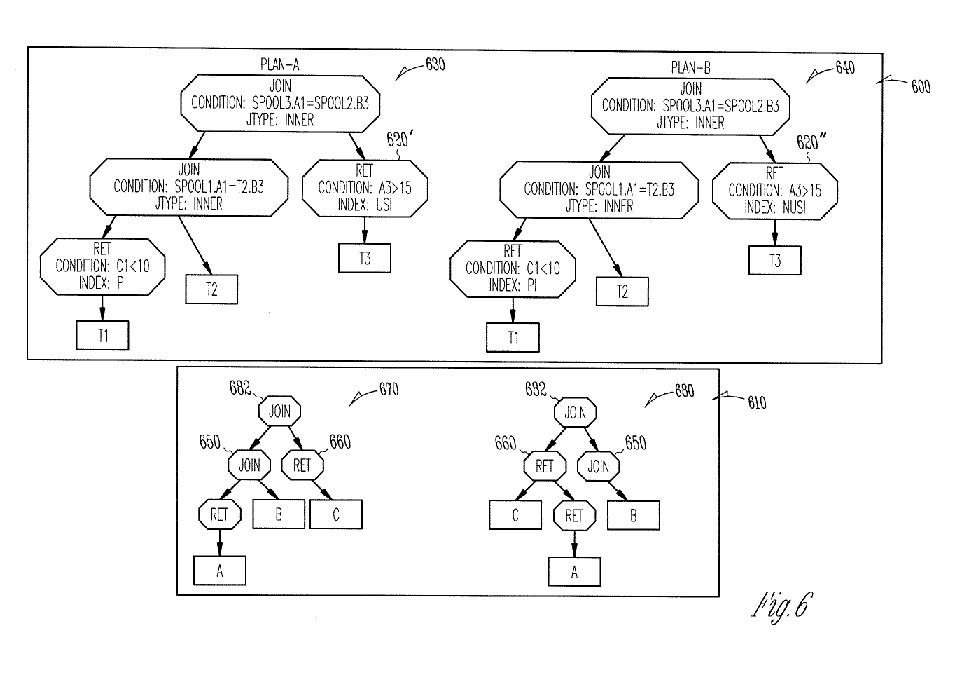

FIG. 6 includes block diagrams 600, 610 of execution plan trees illustrating updated operations and swapped operations, according to various embodiments of the invention. To find updated operations 620, operation signatures in both plans 630, 640 are compared to see if an operation with the same signature exists in both plans, but with different descriptive properties. For example, there is a retrieve operation in both plans 630, 640 that has the same signature. However, the operation 620′ has different descriptive properties when compared to operation 620″. In this case, the operation 620′ specifies a unique secondary index usage (USI), while the operation 620″ specifies a non-unique secondary index usage (NUSI). Therefore, the retrieve operation is updated when it appears as operation 620″.

To find swapped operations 650, 660, operation signatures in both plans 670, 680 are compared to see if the same two operations in the first plan 670 have the same parent 682 as they have in the second plan 680, but with a different order of children. In this case, the join and retrieve operations Join, Ret, respectively, have been swapped in the second plan 680, because the child relations A, B, and C in the first plan 670 have been re-ordered to C, A, and B in the second plan 680. Therefore, the join and retrieve operations Join, Ret comprise swapped operations 650, 660.

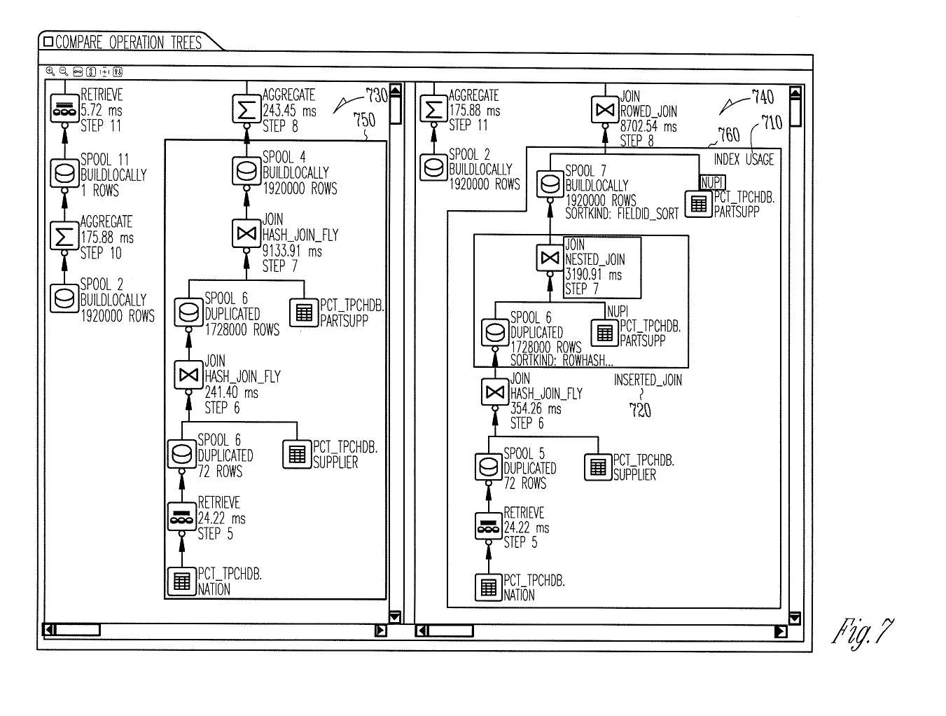

FIG. 7 illustrates a graphical user interface (GUI) 700 that highlights the differences 710, 720 between execution plan trees 730, 740, according to various embodiments of the invention. Here it can be seen that the GUI 700 uses a box cursor 750 to indicate the area to be examined in the first plan tree 730, and another box cursor 760 is used to indicate the corresponding area in the second tree 740. The differences 710, 720 have thus been published in the GUI 700 as hi-lighted text portions (in this case, larger font, and bolded text) of the tree in the second plan 740.

Thus, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

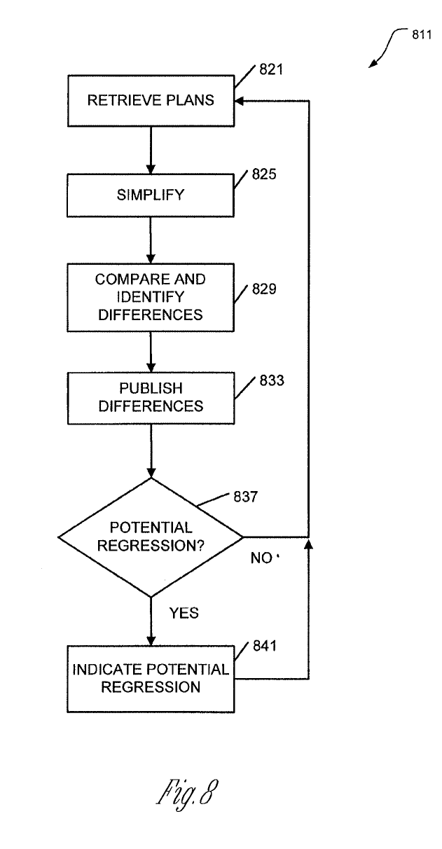

FIG. 8 is a flow diagram illustrating methods 811 to identify and process differences between execution plan trees, according to various embodiments of the invention. The methods 811 are implemented in a machine-accessible and readable medium, and are operational over processes within and among networks. The networks may be wired, wireless, or a combination of wired and wireless. The methods 811 may be implemented as instructions, which when accessed by a specific machine, perform the processing depicted in FIG. 8.

In some embodiments, the method 811 comprises retrieving and comparing two database query plans. The comparison can be made based on join order and/or operation signatures. The differences between the plans may then be published, such as to a disk, a video display, or to a hardcopy printout, among other possibilities.

Thus, a processor-implemented method 811 that can be executed on one or more processors that perform the method may begin at block 821 with retrieving, perhaps by a processing node, at least a portion of a first database query plan comprising a first tree. The activity at block 821 may also include retrieving at least a portion of a second database query plan comprising a second tree. The first and second database query plans may be stored on a storage unit, in main memory, or elsewhere. One or both plans may also be received from a user interface device.

Prior to comparing the trees, unary operations such as retrieve operations and aggregate operations can be collapsed without changing the join order. Thus, the method 811 may include, at block 825, simplifying at least one of the first tree or the second tree by replacing operations having only one degree with a direct link.

To make signature comparison more efficient, some operation properties can be ignored. Thus, the activity at block 825 may include simplifying at least one of the first tree or the second tree by discarding properties associated with the operations, other than those comprising operation type and operands.

The method 811 may continue on to block 829 to include comparing relations and operations in the first tree and the second tree to identify differences in the join order of the relations, and/or deleted, inserted, updated, or swapped operations based on signatures of the operations.

Signature comparison may include comparing key properties of operations. Thus, at block 829, the comparison activity may comprise comparing a first signature associated with one of the operations in the first tree with a second signature associated with one of the operations in the second tree. This may further include comparing key properties in the first signature with key properties in the second signature.

Compile-time trees for two different query plans can be compared. Thus, at block 829, the comparison activity may comprise comparing the first and second trees as compile-time trees to determine estimated relative query plan performance.

Compile-time and run-time trees can be compared to determine the accuracy of query optimizer estimation, and to help improve the accuracy of the optimizer. Thus, at block 829, the comparison activity may comprise comparing the first and second trees to determine a relative performance difference between a compile-time query plan and a run-time query plan.

Query plan trees can be compared to determine what type of indices will be used to retrieve data. Thus, at block 829, the comparison activity may comprise comparing the first and second trees to determine changes in index usage between the first and second trees.

The method 811 may continue on to block 833 to include publishing the differences that have been found. Publication may include rendering the differences in visual form, such as by displaying them on a video display or producing a hardcopy printout. Publication may also be accomplished in other ways, such as by recording the differences to a storage medium. Thus, the activity at block 833 may comprise publishing the differences to one of a storage file or a display, among others.

The differences discovered at block 829 can be indicated graphically, with highlighting in the form of color, geometric shape, font, or line type. Thus, the activity at block 833 may comprise graphically displaying the differences as highlighted portions of the first tree or the second tree.

The method 811 may continue on to block 837, where some embodiments operate to locate problems in a second query plan, such as a trial query plan, which may have been derived from a first query plan, such as an original or reference query plan. Therefore, if no potential regression in performance in the second plan is indicated (e.g., due to the lack of differences discovered with respect to the first plan at block 829), the method 811 may simply return to block 821, to retrieve additional plan data. However, if a potential for regression in performance is indicated by the existence of differences between the plans, as determined at block 837, the method 811 may proceed to block 841 with indicating, using a visual and/or audible alarm, a potential regression in query plan performance based on the differences.

For example, determining the existence of product joins, instead of merge or hash joins, may indicate a problem in one of the query plans. Thus, the activity at block 841 may comprise indicating the potential regression when a product join is found among the differences.

Determining the existence of a redistributed or duplicated spool may indicate a problem in one of the query plans. Thus, the activity at block 841 may comprise indicating the potential regression when a redistributed or duplicated spool is found among the differences.

Determining the existence of a join order change may indicate a problem in one of the query plans. Thus, the activity at block 841 may comprise indicating the potential regression when a one of the relations that is larger than a selected size (e.g., a selected minimum table size) is found, among the differences, to be joined to another one of the relations that is larger than the selected size.

Determining that an expected optimization is missing may indicate a problem in one of the query plans. Thus, the activity at block 841 may comprise indicating the potential regression when the differences show that an expected optimization is missing.

The methods described herein do not have to be executed in the order described, or in any particular order. Moreover, various activities described with respect to the methods identified herein can be executed in repetitive, serial, or parallel fashion. The individual activities of the methods shown in FIG. 8 can also be combined with each other and/or substituted, one for another, in various ways. Information, including parameters, commands, operands, and other data, can be sent and received in the form of one or more carrier waves. Thus, many other embodiments may be realized.

The methods shown in FIG. 8 can be implemented in various devices, as well as in a computer-readable storage medium, where the methods are adapted to be executed by one or more processors. Further details of such embodiments will now be described.

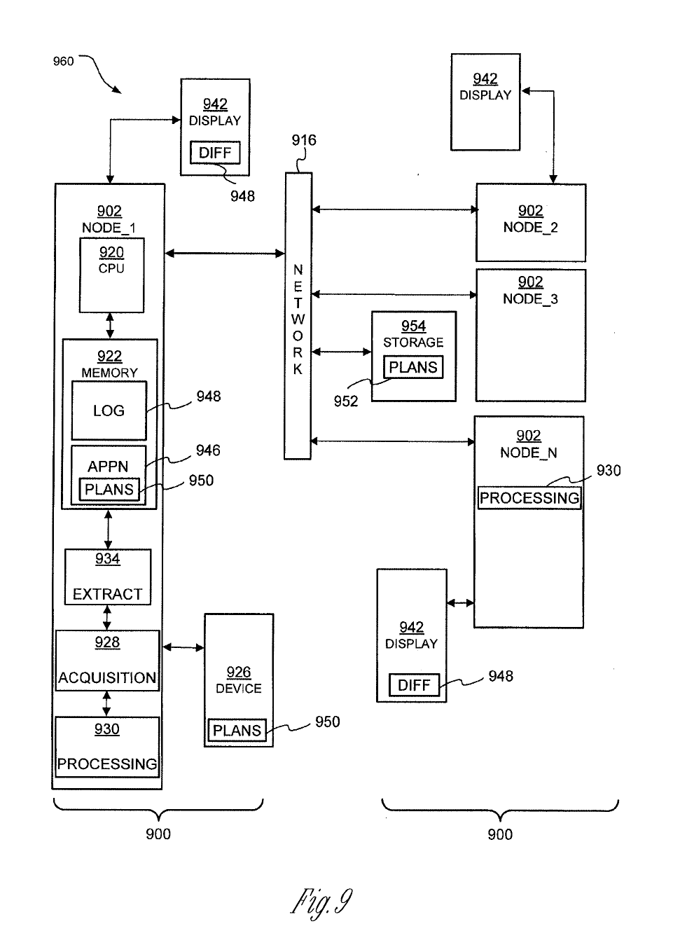

FIG. 9 is a block diagram of apparatus 900 and systems 960 according to various embodiments of the invention. Here it can be seen that an apparatus 900 used to implement tree comparison, publish differences, and indicate potential performance regression may comprise one or more processing nodes 902, one or more processors 920, memories 922, one or more user input devices 926, an acquisition module 928, a processing module 930, and one or more displays 942. The apparatus 900 may comprise a client, a server, or a networked processing node.

The processing nodes 902 may in turn comprise physical machines or virtual machines, or a mixture of both. The nodes 902 may also comprise networked entities, such servers and/or clients. In some cases, the operations described herein can occur entirely within a single node 902.

In some embodiments then, an apparatus 900 may comprise an acquisition module 928 to acquire at least a portion of a first database query plan 950 comprising a first tree and at least a portion of a second database query plan 952 comprising a second tree. The apparatus 900 may further comprise a processing module 930 to compare relations and operations in the first tree and the second tree to identify differences 948 in at least one of join order of the relations, and/or deleted, inserted, updated, or swapped ones of the operations based on signatures of the operations. The processing module 930 may also operate to publish the differences 948.

The apparatus 900 may comprise one or more displays 942. Thus, the apparatus 900 may comprise a display 942 to display the published differences 948.

The apparatus 900 may comprise memory to store the query plans 950, 952. Thus, the apparatus 900 may comprise a storage node 954 to store at least one of the first database query plan 950 or the second database query plan 952 (as shown).

The apparatus 900 may be split into parts, perhaps operating across a network 916: a first part may be used to retrieve the query plans 950, 952, and a second part may be used to process the resulting data. Thus, the apparatus 900 may comprise a first node (e.g., NODE_1) to house the acquisition module 928, and a second node (e.g., NODE_N) to house the processing module 930.

The apparatus 900 may include a terminal or some other user interface device 926 to provide one of the query plans 950, 952. Thus, the apparatus 900 may comprise a user interface device 926 to provide at least a portion of one of the first database query plan 950 (as shown) or the second database query plan 952.

The apparatus 900 may include a query plan extraction module 934 that operates to modify the first query plan 950 to provide the second query plan 952, which can be compared with the first query plan 950 to determine whether improvements have occurred, or whether the second plan 952 represents a regression in performance from the first plan. Of course, those of ordinary skill in the art will realize that in some cases, regressions or improvements may not be determinable using a comparison of compile-time information. In any case, in some embodiments, the first query plan may comprise a reference query plan, and the apparatus 900 comprises a query plan extraction module to derive at least some part of the second database query plan from the first database query plan.

Still further embodiments may be realized. For example, it can be seen that a system 960 that operates to implement tree comparison, publish differences, and indicate potential performance regression may comprise multiple instances of the apparatus 900. The system 960 might also comprise a cluster of nodes 902, including physical and virtual nodes. It should be noted that any of the nodes 902 may include any one or more of the elements explicitly shown in nodes NODE_1, NODE_2, NODE_3, NODE_N.

The apparatus 900 and systems 960 may be implemented in a machine-accessible and readable medium that is operational over one or more networks 916. The networks 916 may be wired, wireless, or a combination of wired and wireless. The apparatus 900 and system 960 can be used to implement, among other things, the processing associated with the methods 811 of FIG. 8. Modules may comprise hardware, software, and firmware, or any combination of these. Additional embodiments may be realized.

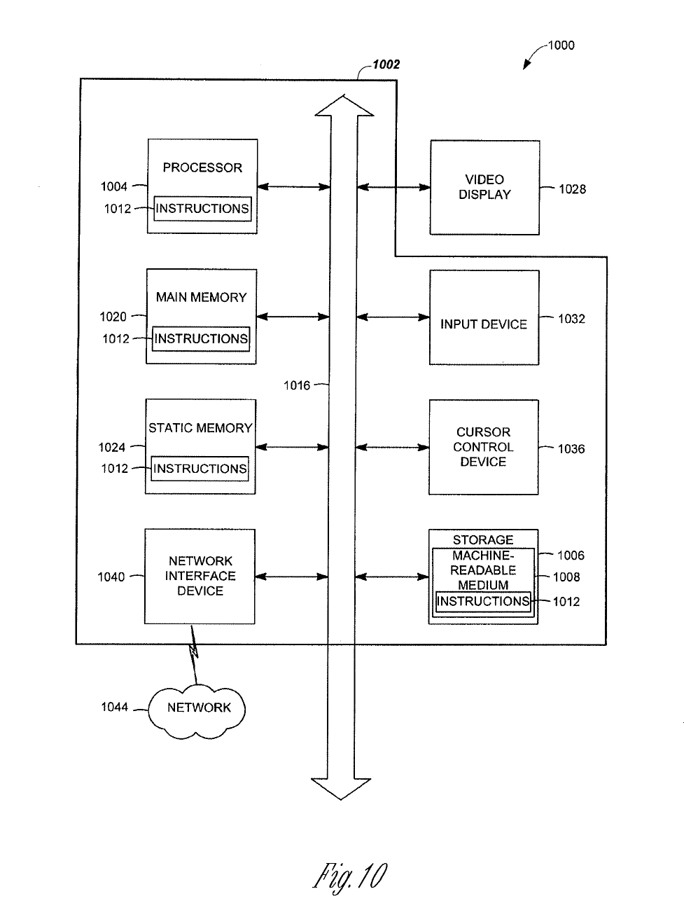

For example, FIG. 10 is a block diagram of an article 1000 of manufacture, including a specific machine, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-oriented format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 1000 of manufacture, such as a computer, a memory system, a magnetic or optical disk, some other storage device, and/or any type of electronic device or system may include one or more processors 1004 coupled to a machine-readable medium 1008 such as a memory (e.g., removable storage media, as well as any memory including an electrical, optical, or electromagnetic conductor) having instructions 1012 stored thereon (e.g., computer program instructions), which when executed by the one or more processors 1004 result in the machine 1002 performing any of the actions described with respect to the methods above.

The machine 1002 may take the form of a specific computer system having a processor 1004 coupled to a number of components directly, and/or using a bus 1016. Thus, the machine 1002 may be similar to or identical to the apparatus 900 or system 960 shown in FIG. 9.

Turning now to FIG. 10, it can be seen that the components of the machine 1002 may include main memory 1020, static or non-volatile memory 1024, and mass storage 1006. Other components coupled to the processor 1004 may include an input device 1032, such as a keyboard, or a cursor control device 1036, such as a mouse. An output device 1028, such as a video display, may be located apart from the machine 1002 (as shown), or made as an integral part of the machine 1002.

A network interface device 1040 to couple the processor 1004 and other components to a network 1044 may also be coupled to the bus 1016. The instructions 1012 may be transmitted or received over the network 1044 via the network interface device 1040 utilizing any one of a number of well-known transfer protocols (e.g., HyperText Transfer Protocol). Any of these elements coupled to the bus 1016 may be absent, present singly, or present in plural numbers, depending on the specific embodiment to be realized.

The processor 1004, the memories 1020, 1024, and the storage device 1006 may each include instructions 1012 which, when executed, cause the machine 1002 to perform any one or more of the methods described herein. In some embodiments, the machine 1002 operates as a standalone device or may be connected (e.g., networked) to other machines. In a networked environment, the machine 1002 may operate in the capacity of a server or a client machine in server-client network environment, or as a peer machine in a peer-to-peer (or distributed) network environment.

The machine 1002 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 1002 is illustrated, the term “machine” shall also be taken to include any collection of machines that individually or jointly execute a set (or multiple sets) of instructions to perform any one or more of the methodologies discussed herein.

While the machine-readable medium 1008 is shown as a single medium, the term “machine-readable medium” should be taken to include a single medium or multiple media (e.g., a centralized or distributed database, and/or associated caches and servers, and or a variety of storage media, such as the registers of the processor 1004, memories 1020, 1024, and the storage device 1006 that store the one or more sets of instructions 1012). The term “machine-readable medium” shall also be taken to include any medium that is capable of storing, encoding or carrying a set of instructions for execution by the machine and that cause the machine 1002 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to compare database query execution plans, such as those generated by database software optimizers. Execution plans in tree format can thus be retrieved and compared to determine the differences between them. Such an approach may be more accurate than simple text comparison, and more robust than manual review by humans.

Several advantages may arise from implementing his comparison mechanism. For example, comparing two plans may indicate that a particular index plan has changed, such as from a secondary index to retrieve information from a given spool in the first plan, to a hash index in the second plan. This kind of difference can be validated as a regression in performance, or an improvement. A few of the many other attributes that can be compared include plan run time, plan CPU time, and plan input/output (I/O) time.

In addition, potential problems, perhaps indicating a regression in performance, may be located more easily. For example, if the second plan has attribute joins, instead of merge or hash joins, this may indicate a problem. Or if an expected optimization is in fact determined to have been deleted, or a spool is duplicated, then a problem may also be indicated. Another potential problem may arise from changes in join order. For example, if a large relation is joined to a large relation, then a problem may exist because the resulting plan might operate to use a lot of resources.

In many instances then, increased accuracy in the interpretation and use of the query plans being compared may result. User satisfaction with use of the optimizer and database software may also increase.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
an acquisition module to acquire at least a portion of a first database query plan comprising a first tree and at least a portion of a second database query plan comprising a second tree; and
a processing module to compare relations and operations in the first tree and the second tree to identify differences in at least one of join order of the relations, and/or deleted, inserted, updated, or swapped ones of the operations based on signatures of the operations, the processing module to publish the differences.

2. The apparatus of claim 1, further comprising:
a display to display the published differences.

3. The apparatus of claim 1, further comprising.
a storage node to store at least one of the first database query plan or the second database query plan.

4. The apparatus of claim 1, further comprising:
a first node to house the acquisition module; and
a second node to house the processing module.

5. The apparatus of claim 1, further comprising:
a user interface device to provide at least a portion of one of the first database query plan or the second database query plan.

6. The apparatus of claim 1, wherein the first query plan comprises a reference query plan, further comprising:
a query plan extraction module to derive at least some part of the second database query plan from the first database query plan.

7. A processor-implemented method to execute on one or more processors that perform the method, comprising:
retrieving, by a processing node, at least a portion of a first database query plan comprising a first tree;
retrieving at least a portion of a second database query plan comprising a second tree, the second database query plan stored on a storage unit;
comparing relations and operations in the first tree and the second tree to identify differences in at least one of join order of the relations, and/or deleted, inserted, updated, or swapped ones of the operations based on signatures of the operations; and
publishing the differences.

8. The method of claim 7, further comprising:
simplifying at least one of the first tree or the second tree by replacing operations having only one degree with a direct link.

9. The method of claim 8, further comprising:
simplifying at least one of the first tree or the second tree by discarding properties associated with the operations other than those comprising operation type and operands.

10. The method of claim 7, wherein the comparing further comprises:
comparing a first signature associated with one of the operations in the first tree with a second signature associated with one of the operations in the second tree by comparing key properties in the first signature with key properties in the second signature.

11. The method of claim 7, wherein the publishing comprises:
publishing the differences to one of a storage file or a display.

12. The method of claim 7, wherein the comparing further comprises:
comparing the first and second trees as compile-time trees to determine estimated relative query plan performance.

13. The method of claim 7, wherein the comparing further comprises:
comparing the first and second trees to determine a relative performance difference between a compile-time query plan and a run-time query plan.

14. The method of claim 7, wherein the comparing further comprises:
comparing the first and second trees to determine changes in index usage between the first and second trees.

15. A processor-implemented method to execute on one or more processors that perform the method, comprising:
comparing relations and operations in a first tree representing at least a portion of a first database query plan and a second tree representing at least a portion of a second database query plan, the comparing to identify differences in at least one of join order of the relations, and/or deleted, inserted, updated, or swapped ones of the operations based on signatures of the operations; and
indicating, using a visual and/or audible alarm, a potential regression in query plan performance based on the differences.

16. The method of claim 15, wherein the indicating further comprises:
indicating the potential regression when a product join is found among the differences.

17. The method of claim 15, wherein the indicating further comprises:
indicating the potential regression when a redistributed or duplicated spool is found among the differences.

18. The method of claim 15, wherein the indicating further comprises:
indicating the potential regression when a one of the relations that is larger than a selected size is found, among the differences, to be joined to another one of the relations that is larger than the selected size.

19. The method of claim 15, wherein the indicating further comprises:
indicating the potential regression when the differences show that an expected optimization is missing.

20. The method of claim 15, further comprising:
graphically displaying the differences as highlighted portions of the first tree or the second tree.
